(19) United States
(12) Patent Application Publication
(10) Pub. No.: US 2022/0276425 A1
(43) Pub. Date: Sep. 1, 2022

(54) MATRIX-ARRAY OPTICAL COMPONENT FOR FOCUSING AN INCIDENT LIGHT BEAM ON A SERIES OF POINTS

(71) Applicant: COMMISSARIAT A L'ENERGIE ATOMIQUE ET AUX ENERGIES ALTERNATIVES, Paris (FR)

(72) Inventor: Christophe MARTINEZ, Grenoble Cedex 9 (FR)

(73) Assignee: COMMISSARIAT A L'ENERGIE ATOMIQUE ET AUX ENERGIES ALTERNATIVES, Paris (FR)

(21) Appl. No.: 17/624,666

(22) PCT Filed: Jul. 2, 2020
(86) PCT No.: PCT/FR2020/051160

§ 371 Date: Jan. 4, 2022

(30) Foreign Application Priority Data
Jul. 5, 2019 (FR) 1907551

(51) Int. Cl. G02B 5/32; G03H 1/02; G02B 3/00; G02B 17/00

(52) U.S. Cl. CPC G02B 5/32; G03H 1/02; G02B 3/0056; G02B 17/002; G03H 2001/022; G03H 2224/06

(57) ABSTRACT

A matrix-array optical component that includes, superposed, a holder, a matrix-array of reflectors and at least one matrix-array of holographic lenses with the holder placed between the matrix-array of reflectors and the at least one matrix-array of holographic lenses. The holographic lenses are each formed by at least one reflection hologram, and each includes a through-aperture for letting light pass. Each individual cell of the matrix-array optical component includes one reflector of the matrix-array of reflectors and one holographic lens of the matrix-array of holographic lenses, which are arranged opposite one another on either side of the holder with respective reflective faces of the reflector and of the holographic lens located facing. Thus, a planar matrix-array optical component with a focusing efficiency higher than or equal to 50% and able to focus an incident light beam axially is produced.

### TECHNICAL FIELD

The invention relates to the field of optical components performing repeated identical or different optical functions according to a mesh covering a surface. It relates more particularly to an array optical component, configured to focus an incident light beam on a plurality of points.

### STATE OF PRIOR ART

In prior art, arrays of microlenses are known, making it possible especially to focus a light beam at normal incidence on said array on a series of points. Microlenses are refractive lenses, arranged in a distribution grid with a step generally less than or equal to one millimetre. One drawback of these arrays lies in their surface topology, with a succession of curved surfaces which complicates manufacturing and cleaning steps.

In order to remedy this drawback, an array optical component in which the optical phenomenon used is not light refraction but diffraction can be made. Such a component consists of a series of focusing elements, each formed by alternating opaque and transparent regions which together form a concentric pattern. However, a drawback of this solution is its low focusing efficiency, due to the opacity of a large part of the surface area of the optical component. Focusing efficiency refers to the ratio of the amount of incident light on the optical component to the amount of light focused by the latter. This efficiency can be increased with an alternative in which the alternating opaque and transparent regions are replaced with alternating regions of zero thickness and non-zero thickness (flat zone). However, even in such an alternative the focusing efficiency does not exceed 40%.

One purpose of the present invention is to provide an array optical component configured to focus an incident light beam on a plurality of points, and which does not have the drawbacks of prior art.

In particular, one purpose of the present invention is to provide such an array optical component, which has both a surface topology with no curved surface, and a high focusing efficiency, greater than or equal to 50%.

Another purpose of the present invention is to provide such an array optical component, which can be configured to on-axis focus a light beam impinging thereon at normal incidence.

### DISCLOSURE OF THE INVENTION

This aim is achieved with an array optical component, including a plurality of individual cells, or pixels, and configured to focus an incident light beam at a plurality of points, and which comprises:

a support;

an array of reflectors; and

at least one array of holographic lenses, wherein each holographic lens is formed by at least one reflection hologram;

with the support being disposed between the array of reflectors and the at least one array of holographic lenses, and

with each individual cell of the array optical component including a reflector of the array of reflectors and a respective holographic lens of each of the at least one array of holographic lenses, with the reflector and holographic lens being disposed opposite to each other on either side of the support and with respective reflective faces of said reflector and said holographic lens located facing each other.

According to the invention, each holographic lens of the at least one array of holographic lenses is provided with a respective through opening. Said through opening is optically transparent to at least one focusing wavelength of the holographic lens. It may be filled with a material optically transparent to at least one focusing wavelength of the holographic lens, or left free. Said through opening allows light to pass at each of the individual cells of the array optical component. The at least one through opening is completely surrounded by the holographic lens.

In the array optical component according to the invention, each individual cell includes a holographic lens, that is a focusing element which does not have a surface topology with curved surfaces. A holographic lens is an optical component well known to the person skilled in the art, formed by at least one hologram, or interference pattern, recorded in a photosensitive writing support. The hologram is made by causing a reference light beam and an object light beam to interfere in the photosensitive writing support, the object light beam having previously passed through refractive optics whose optical function is desired to be reproduced. In use, when the hologram is illuminated with a light beam similar to the reference light beam, it returns a light beam similar to the object light beam in response. A holographic lens is configured to operate at a predetermined wavelength, called the focusing wavelength, corresponding to the wavelength of the object and reference light beams.

According to the invention, each holographic lens is formed by at least one reflection hologram. This is the type of hologram made when the reference light beam and the object light beam are incident on two opposite faces of the photosensitive writing support. In use, the reflection hologram is illuminated by a light beam impinging on a first of its faces, and returns a light beam emerging from that same face in response. As light impinges and emerges from the reflection hologram from the same side of the hologram, it is necessary, for practical reasons, that the light beams impinging and emerging from the hologram are tilted relative to each other. The reflection hologram, considered alone, does not therefore make it possible to perform on-axis focusing of a light beam impinging thereon at normal incidence. However, it is advantageous that the optical component according to the invention can be configured to on-axis focus a light beam impinging thereon at normal incidence. For this, each individual cell of said component further includes a reflector, with a reflective face of the reflector disposed opposite to the reflective face of the at least one reflection hologram. The reflective face of a reflecting hologram refers to the face from which it receives and then reflects light.

In each individual cell, the at least one reflection hologram is configured to receive a collimated light beam, and to concentrate this beam around a so-called virtual focus point, located on the side of the reflector opposite to the hologram. On the way, light reflected by the hologram reaches the reflector on which it is reflected, so as to return towards the hologram. It is finally focused at a focus point located below the reflector (on the same side of the reflector as the hologram). The at least one reflection hologram is provided with a through opening to let the light pass through. The light can thus be focused to a focus point outside the individual cell. Alternatively, light is focused inside the individual cell and the focus point can thus be observed or imaged from outside said individual cell.

The array optical component according to the invention thus forms an array of so-called folded holographic lenses. This configuration is close to what can exist in the field of telescopes, but it is implemented in a completely different field. In particular, it allows each individual cell to be configured to perform on-axis focusing of a light beam impinging thereon at normal incidence. Impingement at normal incidence on an individual cell means that the light rays impinging on the individual cell are all oriented along an axis orthogonal to said plane of the individual cell. The plane of each individual cell here extends parallel to the array of reflectors, as well as to the array of holographic lenses and the upper and lower faces of the support. On-axis focusing means that the individual cell receiving light rays impinging thereon at normal incidence focuses these rays on a focus point located along the axis of incidence, where the axis of incidence is centred to said individual cell and oriented along the normal to said individual cell.

The array of reflectors, like the support, does not result in the presence of curved surfaces on an outer face of the array optical component according to the invention. This component therefore has a surface topology with no curved surface. It even forms a planar component, if the thickness of the reflectors is ignored.

The holographic lenses can achieve a focusing efficiency close to 100%. Additional elements such as the reflectors and support do not result in a significant reduction of this efficiency. The focusing efficiency of the array optical component according to the invention is then only limited by the coverage rate of the individual cells by the reflectors. It can be shown that the focusing efficiency of the array optical component according to the invention can therefore be greater than or equal to 50%, and up to at least 75%.

Another advantage of the array optical component according to the invention is its small thickness, which may be less than or equal to one millimetre and even less than or equal to 200 μm. This reduced thickness is related especially to the beam folding implemented in said component.

Advantageously, one or less, or each of the individual cells of the array optical component according to the invention is configured to focus a light beam impinging thereon in the axis of incidence. In other words, the focus point is located along the axis of incidence of the light beam impinging on the individual cell, with the axis of incidence preferably passing through the geometric centre of said cell. Advantageously, the axis of incidence extends along the normal to the plane of the array optical component.

In at least one, or all, of the individual cells of the array optical component, the through opening in the respective holographic lens of each of the at least one array of holographic lenses may be centred to the individual cell.

In at least one, or all, of the individual cells of the array optical component, the through opening advantageously extends along a surface registered within a projection of the reflector in the plane of the at least one array of holographic lenses (especially an orthogonal projection in that plane).

In at least one, or all, of the individual cells of the array optical component, the reflector may be formed by a dichroic mirror, optically reflective at at least one focusing wavelength by each respective holographic lens of the same individual cell.

Additionally or alternatively, in at least one, or all, of the individual cells of the array optical component, the reflector may be formed by at least one reflection hologram (optically reflective at at least one focusing wavelength by each respective holographic lens of the same individual cell). Said reflector may be capable of reflecting light at a reflection angle distinct from the incidence angle, in absolute value.

In at least one, or all, of the individual cells of the array optical component, the respective holographic lens of each of the at least one array of holographic lenses is formed by a plurality of elementary holograms each configured to deflect light by a predetermined angle.

Further advantageous characteristics of the array optical component according to the invention are mentioned in the claims.

The invention also covers an optical system as mentioned in the set of claims.

The invention also covers a replication optical component as mentioned in the set of claims.

The invention further covers a manufacturing method as mentioned in the set of claims.

The invention also covers a second replication optical component as mentioned in the set of claims.

### BRIEF DESCRIPTION OF THE FIGURES

The present invention will be better understood upon reading the description of exemplary embodiments given purely by way of indicating and in no way limiting purposes, with reference to the appended drawings in which:

FIG. 1A schematically illustrates, and in a transparency and perspective view, a first embodiment of an array optical component according to the invention;

FIG. 1B schematically illustrates, and in a cross-section view, the operation of the array optical component of FIG. 1A;

FIG. 2 schematically illustrates, and in a transparency and perspective view, a second embodiment of an array optical component according to the invention;

FIG. 3A schematically illustrates, and in a cross-section view, the path of light in the array optical component of FIG. 1A;

FIG. 3B schematically illustrates, and in a cross-section view, extreme rays that define the path of light in the array optical component of FIG. 1A;

FIG. 3C illustrates the angular deflection provided by the holographic lens in the array optical component of FIG. 1A, as a function of a position on said lens;

FIG. 4 schematically illustrates, and in a cross-section view, an individual cell of a third embodiment of an array optical component according to the invention;

FIG. 5A and FIG. 5B schematically illustrate, respectively in a cross-section view and a top view, a system including an array optical component according to the invention;

FIG. 6 schematically illustrates a first example of a method for manufacturing an array optical component according to the invention;

FIG. 7A, FIG. 7B, FIG. 7C, FIG. 7D, FIG. 7E, schematically illustrate a second example of a method for making an array optical component according to the invention; and

FIG. 8 schematically illustrates, and in a cross-section view, a fourth embodiment of an array optical component according to the invention.

### DESCRIPTION OF PARTICULAR EMBODIMENTS

For ease of reading, the axes of an orthonormal reference frame (Oxyz) have been represented in some of the figures.

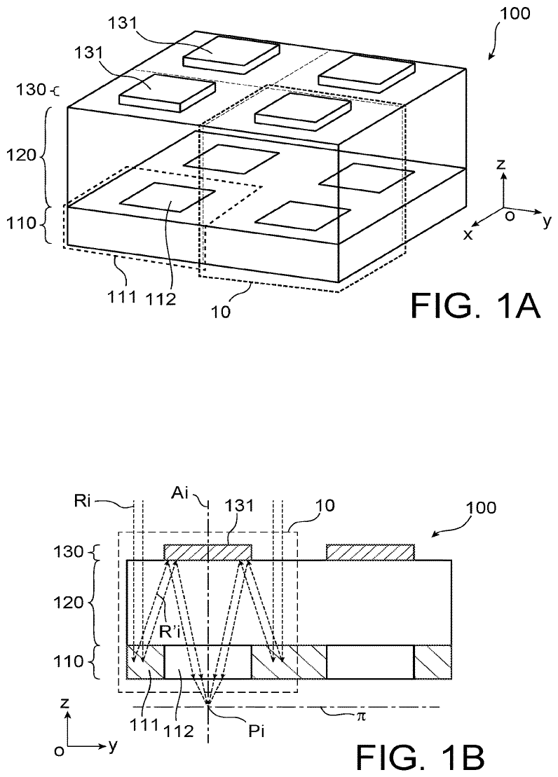

FIG. 1A illustrates, in a perspective view, a first embodiment of an array optical component 100 according to the invention. The array optical component 100 is a monolithic component which includes, being superimposed along the axis (Oz), an array 110 of holographic lenses 111, a support 120, and an array 130 of reflectors 131. Each of the array 110 of holographic lenses, the support 120 and the array 130 of reflectors extends in a respective plane parallel to the plane (Oxy).

A series of individual cells 10 are defined in the array optical component 100, each comprised of a holographic lens 111 of the array 110, a portion of the support 120, and a reflector 131 of the array 130. In each individual cell, the holographic lens 111 and the reflector 131 are aligned along the axis (Oz), disposed opposite to each other on either side of the portion of the support 120.

Each of the holographic lenses 111 of the array 110 is formed here by a reflection hologram. This reflection hologram is configured to receive and reflect light through the same face, called the reflective face, located on the side of the array 130 of reflectors. This reflection hologram, considered alone, is configured to concentrate an incident beam of light rays in a region located in the direction of the array 130 of reflectors.

Each holographic lens is adapted to focus light at a specific wavelength, called the focusing wavelength. The array 110 of holographic lens 111 is formed in a solid layer of photosensitive material, in this case a photosensitive polymer. In the absence of a hologram etched thereinto, said layer of photosensitive material is optically transparent to the at least one focusing wavelength of the holographic lenses. It therefore has a transmission rate at this wavelength of 80% or more, and even 95% or more.

Each holographic lens 111 is open, that is provided with a through opening 112 opening into planes parallel to the plane (Oxy). Here, the through opening 112 is centred to the centre of the holographic lens, but the person skilled in the art will easily understand upon reading the description that this centred feature is not essential to solve the technical problem underlying the invention. The through opening 112 lets light pass through at the focusing wavelength of the holographic lens. Here, the through openings 112 are each filled with the material of the solid layer of photosensitive material.

Here, the holographic lenses 111 are distributed according to a square mesh distribution grid. Here, the shape of the holographic lenses 111 is adapted to allow them to be arranged adjacent to each other in twos, with no free space between two neighbouring holographic lenses 111. Here, each holographic lens 111 thus has the shape of a first rectangular parallelepiped with a square cross-section, provided with a through opening 112 as mentioned above. Here, the through opening has the shape of a second rectangular parallelepiped with a square cross-section, which is disposed aligned and concentric relative to the first rectangular parallelepiped.

The support 120 is a planar component, that is with two planar faces parallel to each other and to the plane (Oxy). It is made of a material that is transparent to at least one focusing wavelength by the holographic lenses 111, with a transmission rate at this wavelength greater than or equal to 80%, and even greater than or equal to 95%. It can be made of a glass or plastic slide, for example PET.

Each of the reflectors 131 of the array 130 of reflectors is formed here by a metal element, optically reflective at the at least one focusing wavelength by the holographic lenses 111, with a reflection rate at this wavelength greater than or equal to 80%, and even greater than or equal to 95%. Each of the reflectors 131 is optically reflective, especially at one of its faces, called the reflective face, located on the side of the array 110 of holographic lenses 111. Here, each of the reflectors 131 implements a so-called specular reflection, in which a light ray impinging on the reflector 131 while being tilted by an angle α relative to the normal to the plane of the reflector is reflected in a direction tilted by an angle -a relative to said normal.

Here, the reflectors 131 are formed by distinct elements, spaced apart from each other. Here, the reflectors 131 are each formed by a thin blade with a square main surface. They are distributed according to the same distribution grid as the holographic lenses 111. One holographic lens 111 corresponds to each reflector 131, both elements being aligned together along an axis parallel to the axis (Oz).

In each individual cell 10, the reflector 131 covers only part of the upper surface of the individual cell. The shape of the reflector 131 is adapted to allow incident light to reach the array 110 of holographic lenses by propagating around the reflectors 131 and into the support 120.

Advantageously, and as represented in FIG. 1A, in each individual cell 10 the through opening 112 in the holographic lens 111 is registered within a projection of the reflector 131 in the plane of the array 110 of holographic lenses, preferably an orthogonal projection. Said through opening 112 may extend exactly along the stretch of said orthogonal projection, or along a lesser stretch (for example to absorb angular deviation of the incident light beam, misalignment of the respective reflective faces of the reflector and the holographic lens located, etc).

The upper face of the array optical component 100 is formed by the upper face of the array 130 of reflectors 131, on the side opposite to the support 120. This face follows the topology of the reflectors 131, consisting of blades disposed on a flat support 120. This face is therefore substantially planar, and with no curved surface.

FIG. 1B schematically illustrates, and in a cross-section view in a plane (Oyz), the array optical component 100.

In FIG. 1B, a beam of light rays Ri, incident on an individual cell 10 of the array optical component 100, has been represented. The light rays Ri impinge on the individual cell 10 at the array 130 of reflectors 131. They are parallel to each other, and impinge here at normal incidence on said individual cell 10, that is here oriented along the axis (Oz).

In the individual cell 10, light rays Ri pass through the array of reflectors 131 at regions surrounding the reflector 131, pass through the support 120 and reach the hologram lens 111.

The holographic lens 111 concentrates these rays Ri onto a region in the direction of the array of reflectors 131. The rays thus reflected by the holographic lens 111, denoted as R′i, propagate in the individual cell 10 to the reflector 131, at which they are reflected in the direction of the same holographic lens 111. They impinge, however, at the level of the holographic lens at the opening 112 in the latter, so that they pass through the array 110 of holographic lenses and emerge out of the array optical component 100. Said emerging rays all intersect at a same point Pi, on the side of the array 110 of holographic lenses.

Here, the point Pi lies on an axis Ai, called the axis of incidence, centred to the individual cell 110 and parallel to the light rays Ri impinging at normal incidence on the individual cell. In other words, the individual cell 10 is configured here to perform an on-axis focusing of the light rays impinging thereon at normal incidence. This on-axis focusing is achieved by adapting dimensions of the elements making up the individual cell. Examples of the dimensions of these elements are described below.

Preferably, each of the individual cells 10 of the array optical component 100 is configured to focus, at a respective point Pi, a collimated beam of light rays impinging at normal incidence on said individual cell, and the different points Pi associated with the different individual cells of the array optical component 100 all extend in a same plane π parallel to the plane (Oxy) (parallel to upper and lower faces of the support, to the array 110 of holographic lenses and to the array 130 of reflectors). This plane π here extends outside the array optical component 100, on the side of the array 110 of holographic lenses. According to one alternative not shown, the plane π extends on the same side of the array 110 of holographic lenses as the support 120, if necessary within the support 120 itself.

According to other alternatives, not all the points Pi associated with the different individual cells of the array optical component 100 extend in a same plane π parallel to the plane (Oxy). In other words, not all the holographic lenses of the array of holographic lenses then have the same focal length value.

Here, the array optical component 100 includes a single array 110 of holographic lenses. The different holographic lenses 111 in said array may all have the same focusing wavelength. Alternatively, said array includes different types of holographic lenses 111 that differ in their focusing wavelength. The different types of holographic lenses 111 may be distributed in a regular distribution grid, consisting of macro-pixels that each include at least one holographic lens of each type. The different types of holographic lenses are, for example, associated with focusing wavelengths in blue (470-490 nm), green (520-570 nm) and red (600-650 nm) ranges respectively. Preferably, all the different focusing wavelengths are focused in a same plane π parallel to the plane (Oxy). The focus points associated with the three colours blue, green and red then extend side by side in a same plane parallel to the plane (Oxy). The array optical component can thus form a colour display screen.

According to one alternative not represented, the array optical component includes a plurality of arrays of holographic lenses, superimposed with each other along the axis (Oz), on the side of the support opposite to the array of reflectors. Advantageously, in each of all said arrays the holographic lenses have the same focusing wavelength, and the different arrays of holographic lenses each have a distinct focusing wavelength. For example, the different arrays of holographic lenses have a focusing wavelength in blue (470-490 nm), green (520-570 nm) and red (600-650 nm) ranges respectively. All the different focusing wavelengths are preferably focused in a same plane π parallel to the plane (Oxy). This plane thus receives a series of polychromatic focus points, each formed by superimposing focus points associated with blue, green and red respectively. Again, the array optical component can thus form a colour display screen.

According to another alternative not represented, not all of the individual cells of the array optical component are configured to perform on-axis focusing of a light beam impinging thereon at normal incidence. In particular, the array optical component may include different types of individual cells, which differ in the associated focusing wavelength and in the lateral offset of the associated focus point relative to the centre of said cell. The different types of individual cells may be distributed in a regular distribution grid, consisting of macro-cells which each include at least one individual cell of each type. Each macro-cell may be associated with one and the same position of the focus point position. All the different focusing wavelengths are preferably focused in a same plane π parallel to the plane (Oxy). This plane thus receives a series of polychromatic focus points, each formed by superimposing focus points associated with, for example, blue, green and red respectively. Again, the array optical component can thus form a colour display screen.

According to another advantageous alternative, the reflectors 131 of the array of reflectors may each be formed by a dichroic mirror, optically reflective at the at least one focusing wavelength by the holographic lenses 111 and optically transparent to other wavelengths. The array optical component according to the invention then has the advantage of being optically transparent.

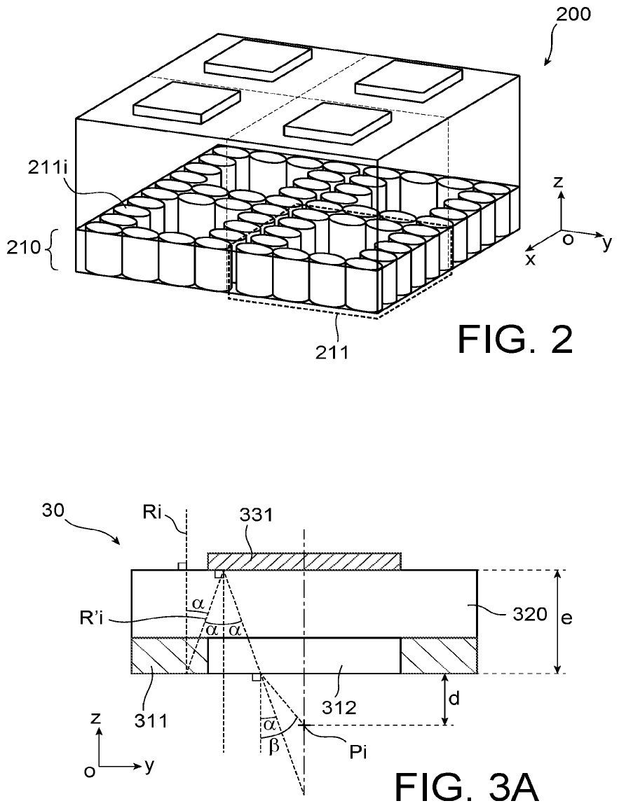

FIG. 2 schematically illustrates, and in a transparency and perspective view, an array optical component 200 according to a second embodiment of the invention.

The array component 200 differs from the first embodiment only in that each of the holographic lenses 211 of the array 210 of holographic lenses is formed by a plurality of elementary reflection holograms 211i. The elementary holograms 211i each have the shape of a cylinder of revolution, with a generatrix parallel to the axis (Oz). For legibility reasons of the figure, the elementary holograms 211i are represented adjacent to each other. In practice, they may be partially superimposed in twos, so as to limit non-written surfaces between neighbouring elementary holograms. Each elementary hologram 211i is configured to reflect a beam of rays incident thereon at normal incidence in a predetermined direction. Each holographic lens includes, for example, at least 16 elementary holograms. The greater the number of elementary holograms, the better the focusing by the holographic lens.

A method for manufacturing such a holographic lens is described in the paper “Holographic Recording Setup for Integrated See-Through Near-Eye Display Evaluation”, Christophe Martinez & al, Imaging and Applied Optics 2017, OSA Technical Digest (Optical Society of America, 2017), paper JTu54.36. This method is based on angularly sampling the optical function of the lens, according to a mesh of elementary holograms. It uses a printing bench with a movable optical fibre to successively orient the object beam at different values of incidence angle, while the reference beam remains fixed. At each offset in the position of the optical fibre, a writing layer of photosensitive material is laterally offset relative to the object and reference beams, so as to successively register the plurality of elementary holograms.

Each of the individual cells of the array optical component 200 may be configured to focus a light beam impinging thereon at normal incidence in the axis of incidence. Alternatively, the elementary holograms may be adapted so that the focus point associated with the individual cell is laterally offset relative to the axis of incidence.

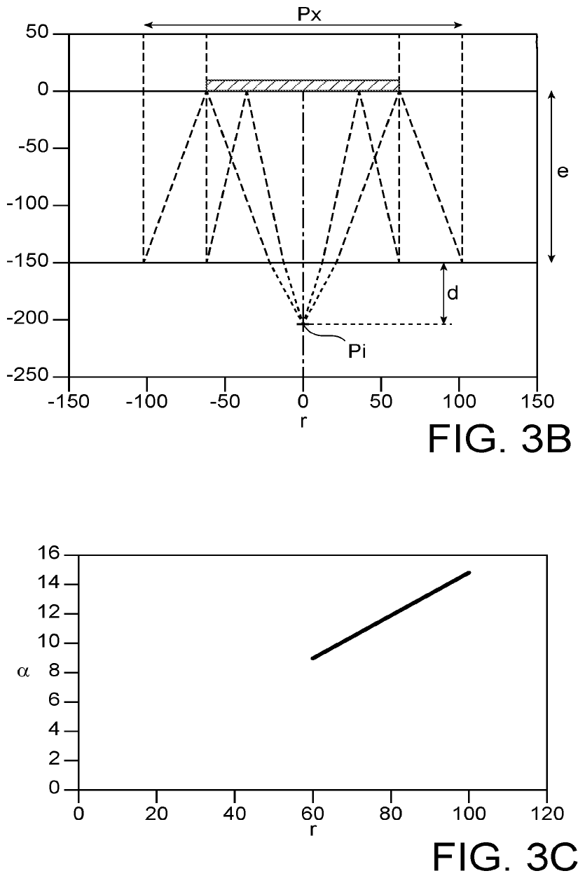

FIG. 3A illustrates, in a cross-section view in a plane (Oyz), an individual cell 30 of an array optical component as illustrated in FIG. 1A, as well as the path travelled by a light ray Ri impinging at normal incidence on said individual cell 30, on the side of the reflector 331.

This light ray Ri impinges on the individual cell in a region of the individual cell not covered with the reflector 331. It passes through the support 320 without being deflected (because of its normal incidence), and reaches the holographic lens 311.

At the holographic lens 311, it is reflected towards the reflector 311, forming an angle α with the normal to the plane of the individual cell (where the plane of the individual cell is parallel to the axis (Oxy)). Said ray reflected by the holographic lens 311 is denoted as R′i.

The ray R′i reaches the reflector 311, where it is reflected according to a so-called specular reflection, that is along an axis forming an angle α, in absolute value, with the normal to the plane of the individual cell. The ray R′i then propagates into the support 320, and then passes through the opening 312 at the centre of the holographic lens 311. The optical indices of the support 320 and the photosensitive material filling the opening 312 are close to each other, so that the effect of refraction at the interface between these two media is ignored here.

This ray then emerges out of the array optical component according to the invention. It is deflected by refraction at the interface between the photosensitive material filling the opening 312 and the surrounding medium (generally air). It then propagates to the focus point Pi, along an axis forming an angle β with the normal to the plane of the individual cell. The ray as it would emerge from the array optical component in the absence of refraction has also been represented in FIG. 3A.

A distance d, called the working distance, is defined as the distance between the focus point Pi and the lower face of the array optical component, on the side opposite to the array of reflectors. A thickness e is also defined, which is the distance between an upper face of the support 320, on the side of the reflectors, and said lower face of the array optical component. It is also considered that the array optical component has a same optical index n throughout its volume. This approximation is realistic.

It can be considered that the focusing efficiency of the holographic lens 311 is 100%, and that the reflector 331 does not reduce this efficiency. The focusing efficiency of the individual cell 331 is therefore defined by the ratio η of the surface area of the individual cell not covered by the reflector 331 to the total surface area of the individual cell.

In the small angle approximation (where sin(θ)=θ and cos(θ)=1), and with a reflector 331 whose shape is a homothety of the cross-section of the individual cell (for example a square reflector in a square individual cell), there is:

$$η = 1 - {( 1 - \frac{e}{n * d + 2 e} )}^{2} \qquad ( 1 )$$

It can be shown that, in this configuration and with the approximations considered, the focusing efficiency can reach 75%. The lower the working distance d, the higher the efficiency. In other words, this efficiency is higher the closer the thickness e defined above is to half the focal length f of the holographic lens 311 (due to beam folding).

In practice, the individual cell can be dimensioned from a desired distribution step Px of the individual cells, a desired thickness e and a desired distance d. From these data, the size of the reflector is deduced (see FIG. 3B, where e=150 μm, d=53 μm, and Px=100 μm). The focusing efficiency of the array optical component (63% in the example of FIG. 3B) is then deduced from the size of the reflector.

The focal length f of the holographic lens 331 is defined using the relationship:

f=2*e+d (2)

In the embodiment of FIG. 2, the holographic lens consists of a plurality of elementary holograms, each of which performs a deflection of the beam by a specific angle α. In order to reproduce the behaviour of a lens of focal length f, the angle α obeys a function which depends on the distance r between a central axis of the individual cell considered, and a central axis of the elementary hologram considered. In the small angle approximation, this function is shown to be defined by:

$$α = {tan}^{- 1} ( \frac{r}{2 e + n * d} ) \qquad ( 3 )$$

FIG. 3C illustrates the value of the angle α (in degrees of angle) as a function of r (in μm), for e=150 μm and d=53 μm.

It is noticed that the function in equation (3) is only valid in the small angle approximation, corresponding to a low numerical aperture value (low value of the ratio of step Px to thickness e). For large values of the numerical aperture, the value of the angle α obeys a more complex function (which can be easily defined using the Snell-Descartes relationship).

FIG. 4 schematically illustrates, in cross-section view, an individual cell 40 of an array optical component according to a third embodiment of the invention.

This embodiment differs from that of FIGS. 1A and 1B only in that, in each individual cell 40, the reflector 431 is not formed by a specular reflection element but by a holographic lens working in reflection. Said lens may consist of a single reflection hologram, or of a plurality of elementary reflection holograms as described above.

Consequently, a light ray impinging on the reflector 431 while being tilted by an angle α relative to the normal to the plane of the reflector is not necessarily reflected in a direction tilted by an angle α in absolute value relative to said normal. Here it is reflected in a direction tilted by an angle γ distinct from α in absolute value. The value of the angle γ may be a function of the distance r′ between a central axis of the individual cell and a point of incidence of the light ray on the reflector 431. Alternatively, the value of the angle γ may be a constant that does not depend on the position of the point of incidence considered on the reflector 431.

This embodiment especially allows the reflector 431 to be adapted in such a way as to guarantee a high focusing efficiency, even for a high working distance d.

In one particular embodiment, the holographic lens 411 is configured to return, along a same orientation, any light ray impinging thereon at normal incidence, regardless of the point of incidence of this ray on said lens. In other words, the tilt angle α of the ray reflected by said lens is a constant. Such a characteristic is easily implemented when the holographic lens consists of a plurality of elementary holograms, as illustrated in FIG. 2. Light rays returned by the holographic lens 411 therefore all impinge on the reflector 431 at the same incidence angle α (in absolute value). There is for example (with a reflector whose side is half as wide as the side of the individual cell):

$$α = {tan}^{- 1} ( \frac{P x}{2 * e} ) \qquad ( 4 )$$

where Px is the distribution step of individual cells and e is the thickness as defined above.

From this, a function is deduced defining the value taken by the angle y as a function of the position considered on the reflector, and for obtaining the desired working distance d. It can be shown that when the value of the working distance is high, especially in comparison with the thickness e defined above, it is possible to achieve a high focusing efficiency. For example, for e=60 μm, d=500 μm, and Px=130 μm, this alternative makes it possible to obtain a focusing efficiency of 75%, whereas this efficiency would only be 13% in the embodiments with a specular reflection reflector. In particular, this alternative allows for a reduction in a coverage rate of the individual cell by the reflector, which increases focusing efficiency.

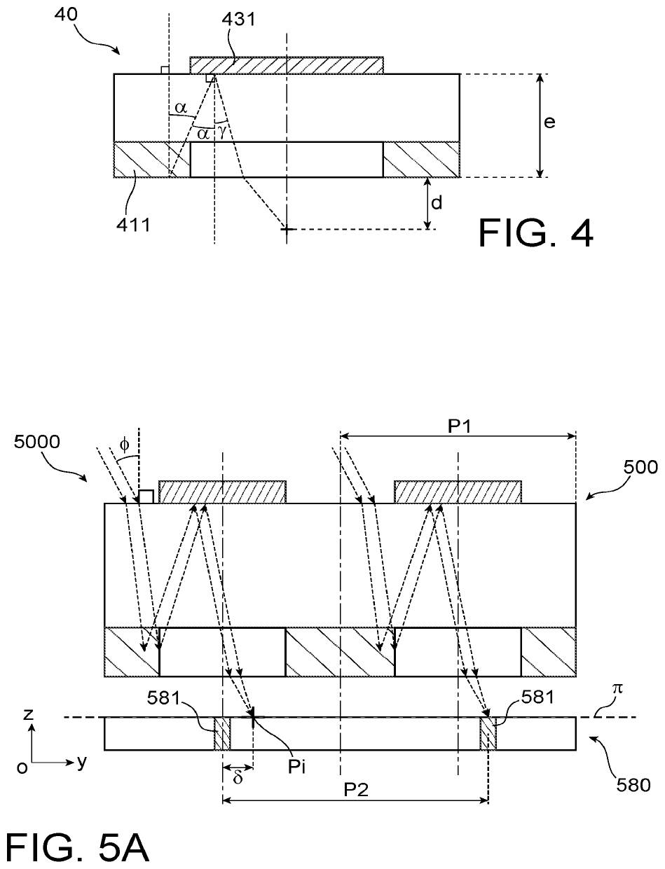

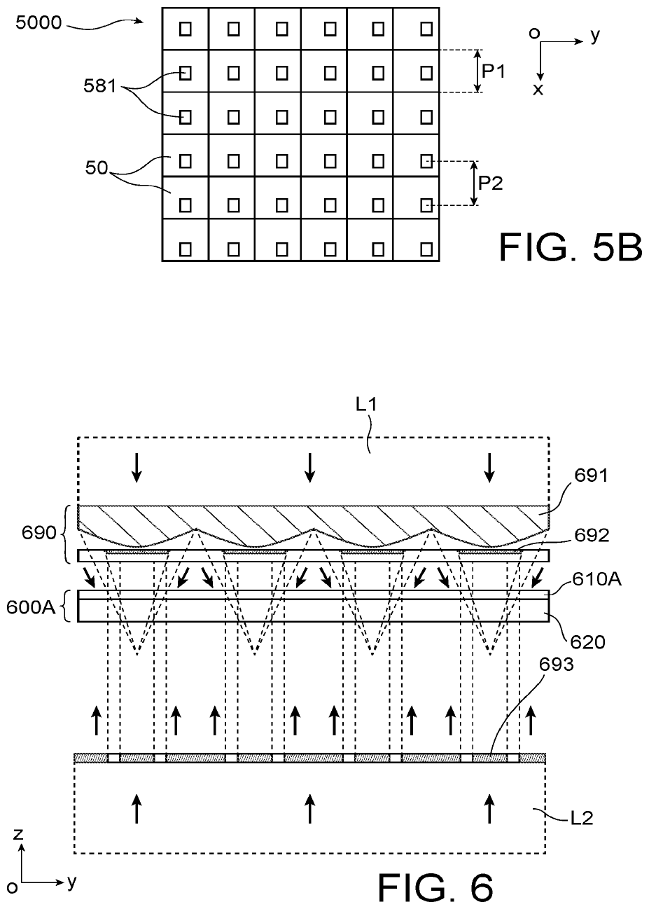

FIGS. 5A and 5B schematically illustrate an optical system 5000 according to the invention, respectively in a cross-section view and a top view. The optical system 5000 includes an array optical component 500 according to the invention, in which the individual cells are distributed according to a regular mesh distribution grid, in this case a square mesh of step P1. The optical system 5000 also includes photodetectors 581, together forming an array 580 of photodetectors.

The array optical component 500 and the array 580 of photodetectors are superimposed on top of each other along the axis (Oz), where the axis (Oz) is orthogonal to the plane of the array optical sensor 500 and the plane of the array 580 of photodetectors. The array 580 of photodetectors extends in particular in the plane π receiving the focus points of the individual cells of the optical matrix sensor 500.

Each photodetector 581 of the array 580 of photodetectors extends facing a respective individual cell 50 of the array optical component 500. Preferably, one and only one photodetector of the array 580 of photodetectors corresponds to each individual cell 50 of the array optical component 500.

The photodetectors 581 each have a detection surface with a smaller area than an individual cell 50 of the array optical component 500, and they are not all positioned in the same way relative to the corresponding individual cell 50.

Here, advantageously, the photodetectors 581 are distributed according to a distribution grid of square mesh and step P2 distinct from P1 (here, strictly greater than P1). Thus, from one individual cell 50 to another cell of the array optical component, the lateral offset between the centre of said individual cell 50 and the centre of the corresponding photodetector 581 slightly varies. Thus, a plurality of lateral offsets can be covered, along each of the axes (Ox) and (Oy), between the centre of an individual cell 50 and the centre of the corresponding photodetector 581 (see FIG. 5B).

As illustrated in FIG. 5A, when light rays incident on the array optical component 500 are tilted by an angle ϕ relative to the normal to said component, this results in respective lateral offsets δ between the focus points Pi of these rays in the plane π and the respective central axes of the individual cells 50 of the array optical component 500. Depending on the position of the photodetector 581 relative to the centre of the individual cell 50, said photodetector 581 will therefore receive or not receive light radiation. Thus, for example, of all the photodetectors 581 in the array 580 of photodetectors, only the one (or ones) with that offset δ relative to the centre of the corresponding individual cell 50 will detect a signal. Which photodetector 581 detects a signal being known, the tilt angle ϕ of the light rays incident on the array optical component 500 can be determined. Alternatively, several photodetectors 581 will detect a signal, and the determination of the tilt angle ϕ will consist in searching for the photodetector receiving the most intensive signal. The system 5000 may thus form an angular position sensor, to measure a tilt angle of an incident light beam.

According to alternatives not represented, there may be more photodetectors than individual cells of the array optical component, or vice versa.

The array optical component 500 may correspond to any of the embodiments of the invention. Advantageously, the reflectors of its array of reflectors are dichroic mirrors. In this way, a transparent screen can be made which furthermore provides an angular sensor function.

FIG. 6 schematically illustrates a first example of a method for manufacturing an array optical component according to the invention.

This method uses a first replication optical component 690 (also called a “master”), which includes an array of microlenses 691 and a first array of spatial filters 692, superimposed along the axis (Oz) orthogonal to the respective planes of said arrays.

The array of microlenses 691 is an array of refractive lenses, the focal lengths of which are a function of the desired focal lengths for the holographic lenses of the array optical component according to the invention.

The first array of spatial filters 692 is an array of opaque elements, defining shape of the holographic lenses of the array optical component according to the invention. Each of the spatial filters of said array is here centred to the optical axis of a respective one of the microlenses of the array of microlenses 691.

The replication optical component 690 is superimposed above a stack 600A including a support 620 and a writing layer 610A of photosensitive material, with the plane of the replication optical component 690 being parallel to the plane of this stack, and with the first array of spatial filters 692 located opposite to the writing layer 610A.

A second array of spatial filters 693 is disposed below the stack 600A, opposite to the support 620, and with the plane of the second array of spatial filters 693 being parallel to the plane of the stack 610A.

A laser beam is split into two collimated sub-beams L1, L2, both impinging at normal incidence on the assembly including the replication optical component 690, the stack 600A and the second array of spatial filters 693, one on the side of the replication optical component 690, the other on the side of the second array of spatial filters 693. The sub-beams L1 and L2 form an object light beam and a reference light beam, respectively, for registering, into the writing layer 610A, the holographic lenses of the array of holographic lenses of an array optical component according to the invention.

Preferably, the complete array of holographic lenses is made in several elementary registration steps, between which the stack 600A is laterally translated relative to the replication optical component 690 and the second array of spatial filters 693. The manufacture of the array optical component is then terminated by making the array of reflectors, on the support 620, on the opposite side to the array of holographic lenses.

Alternatively, an array optical component according to the invention can be made using the method described with reference to FIG. 2 for making holographic lenses consisting of elementary holograms. The elementary holograms are then registered in a stack including, being superimposed, a writing layer of photosensitive material, a substrate and an array of reflectors, with the substrate between the array of reflectors and the writing layer. The reference light beam impinges on the stack on the side of the array of reflectors. The object light beam impinges on the stack on the side of the writing layer, and is reflected on the reflectors of the array of reflectors.

This alternative provides greater flexibility than the first exemplary method described above, since many kinds of holographic lenses can be made on the same printing bench.

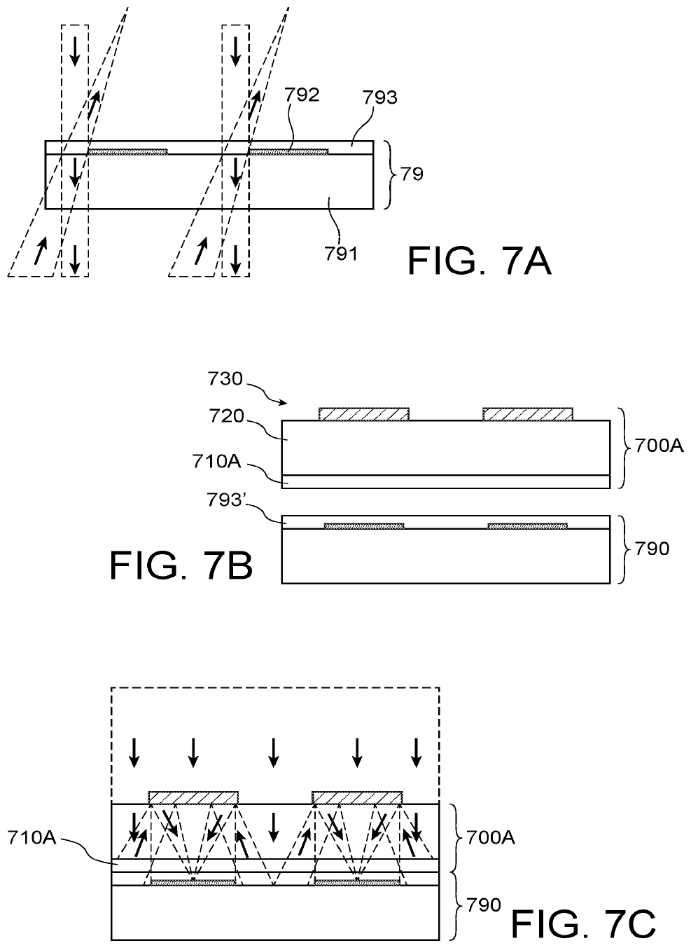

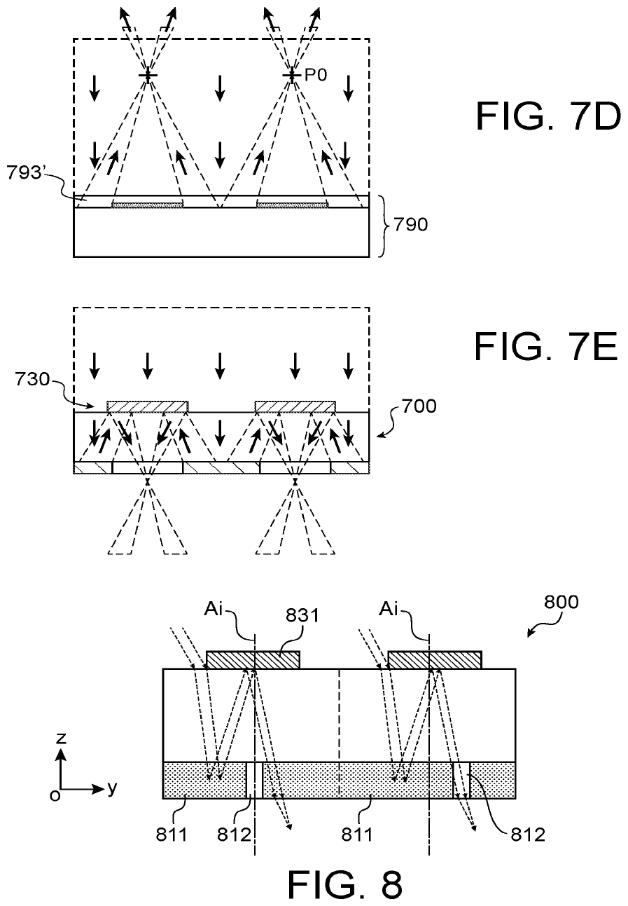

In order to be able to quickly make array optical components with large dimensions, and in which each holographic lens is formed by a sufficient amount of elementary holograms, the inventors also provide an alternative using a replication optical component, or master. FIGS. 7A to 7E schematically illustrate all the steps of the manufacturing method according to this alternative.

In a preliminary step illustrated in FIG. 7A, a replication optical component is manufactured by registering a primary array of reflection holographic lenses in a stack 79. The stack 79 includes, being superimposed, a substrate 791, an array of spatial filters 792, and a first writing layer 793, with the array of spatial filters 792 between the substrate 791 and the first writing layer 793. Said registration is performed using a method such as mentioned with reference to FIG. 2, by exposure of the stack 79, using a reference beam and an object beam taking successively different orientations. The reference beam impinges at normal incidence on the stack 79, on the side of the first writing layer 793. The object beam impinges on the stack 79 on the side of the substrate 791. The array of spatial filters 792 is formed by a series of opaque elements, which block light at the exposure wavelength by the object and reference beams.

FIG. 7D illustrates the replication optical component 790 thus formed, in use. The replication optical component is illuminated by a light beam impinging thereon at normal incidence on the side of the primary array 793′ of holographic lenses. In response, it returns rays which are concentrated at different focus points P0, outside the replication optical component 790 and on the side of the primary array 793′ of holographic lenses. Each holographic lens of said primary array 793′ is provided with an opening that receives an opaque element of the array of spatial filters 792. These opaque elements subsequently define the through openings in the holographic lenses of the array optical component according to the invention. Preferably, in each holographic of said primary array 793′, the opening is centred to said holographic lens and is arranged concentric with the corresponding opaque element.

To make an array optical component according to the invention, the replication optical component 790 and a writing assembly 700A are superimposed with each other. Said writing assembly 700A includes, being superimposed, a second writing layer 710A, a support 720, and an array 730 of reflectors, with the support 720 being disposed between the second writing layer 710A and the array 730 of reflectors. At the end of this step, the second writing layer 710A is between the support 720 and the primary array 793′ of holographic lenses (see FIG. 7B). Here, the second writing layer 710A and the primary array 793′ of holographic lenses are in direct physical contact with each other. Alternatively, they may be separated from each other by a spacer layer that is optically transparent to an exposure wavelength of the second writing layer 710A. In any event, each opaque element of the array of spatial filters 792 is aligned here with a reflector of the array 730 of reflectors.

Next, a secondary array of holographic lenses is registered into the second writing layer 710A, by exposing a stack formed by the writing assembly 700A and the replication optical component 790 that are superimposed with each other. Exposure is carried out using a light beam impinging at normal incidence on said stack, on the side of the array 730 of reflectors (see FIG. 7C). This is therefore reading of the replication optical component 790 that allows the registration of said secondary array of holographic lenses. The reference beam is formed by the light beam impinging at normal incidence on the stack. The object beam is formed by the beam returned in response by the primary array 793′ of holographic lenses and reflected on the reflectors of the array 730 of reflectors. The object beam thus reflected concentrates at a plurality of focus points. A lateral translation of the replication optical component 790 relative to the writing assembly 700A is then implemented, and the step of registering a secondary array of holographic lenses into the second writing layer 710A is repeated. Preferably, a translation by a distance equal to the dimension of the replication optical component along the translation axis is performed. The steps of translation and re-registration are implemented several times, until the entire surface of the second writing layer 710A is registered. Finally, the replication optical component 790 is removed.

FIG. 7E illustrates the array optical component 700 thus produced, in use, when illuminated by a light beam impinging thereon at normal incidence, on the side of the array 730 of reflectors.

The method described above makes it possible to rapidly register holographic lenses each consisting of a plurality of elementary holograms.

However, a similar method can be implemented in which the primary array of holographic lenses in the replication optical component is made by exposure through an array of refractive microlenses.

The invention is not limited to the examples described above, and many alternatives can be implemented without departing from the scope of the invention.

For example, embodiments have been described in which the array of reflectors extends directly onto a first face of the support, and the array of holographic lenses extends directly onto a second face of the support, on the side of the support opposite to said first face. Alternatively, at least one interlayer may extend between the support and the array of holographic lenses, respectively between the support and the array of reflectors. Such an interlayer is optically transparent to at least one focusing wavelength through the array of holographic lenses.

The invention is not limited to holographic lenses, respectively reflectors, distributed in a square mesh distribution grid. Any kind of mesh can be used without departing from the scope of the invention, for example a triangular or hexagonal mesh. Preferably, however, the shape of the holographic lenses is adapted to allow them to be arranged adjacent in twos, with no free space between them. The reflectors of the array of reflectors may be connected in twos by portions of material of the reflectors, as long as a sufficient amount of light can reach the support and the array of holographic lenses. In each individual cell, the cross-section of the opening in the holographic lens does not necessarily correspond to the shape of the reflector. The opening in a holographic lens may be somewhat larger, or somewhat smaller than the reflector, in planes parallel to the plane of the array optical component. Further, the cross-section of the opening in the holographic lens is not necessarily a homothety of the shape of the reflector.

Throughout the text, an operation in receiving mode has been described, in which the array optical component according to the invention receives a collimated incident beam and focuses it onto a series of focus points. The same component can also be used in emission mode, to emit a collimated emission beam using light sources disposed at said focus points.

Throughout the text, through openings in the holographic lenses have been described, each centred to the associated individual cell. Alternatively, in at least one, or all, of the individual cells of the array optic component, the opening in the respective holographic lens of each of the at least one array of holographic lenses is offset relative to a central axis of said individual cell. Stated differently, in at least one of the individual cells, the through opening in the holographic lens is off-centre. FIG. 8 illustrates such an alternative. The array optical component 800 of FIG. 8 differs from the first embodiment of the invention only in that, in at least one of the individual cells, the through opening 810 in the holographic lens 811 is off-centre relative to the central axis Ai, where Ai is parallel to (Oz) and centred to the corresponding individual cell. In the example illustrated in FIG. 8, each through opening 812 further has reduced dimensions in a plane (xOy). For example, a ratio of the cross-section of the reflectors 831 to the cross-section of the through openings 812, in planes (xOy), is greater than or equal to 10. Thus, an angular sensor can be made, on the same principle as illustrated in FIGS. 5A and 5B, with an array optical component in which each individual cell includes a through opening offset by a distinct value relative to the central axis Ai of said cell. The positions of the through openings in the individual cells are defined, upon manufacturing, by positions of the aforementioned opaque elements. Said opaque elements may therefore be off-centre relative to the individual cells when being manufactured.

According to still other alternatives, in at least one of the individual cells, the reflector is off-centre. According to further alternatives, the array optical component is configured to achieve off-axis focusing of a light beam impinging at normal incidence on its individual cells. For this, the method for manufacturing the array of holographic lenses implements beams obliquely tilted relative to the writing layer.

The different individual cells of the array optical component may or may not be distributed in a regular mesh.

The invention finds application in many fields such as wavefront detection, three-dimensional image acquisition, three-dimensional image viewing, light beam tilt angle measurement, etc.

1. An array optical component, including a plurality of individual cells and configured to focus an incident light beam at a plurality of points, comprising:
a support;
an array of reflectors; and
at least one array of holographic lenses, wherein each holographic lens is formed by at least one reflection hologram and the support is disposed between the array of reflectors and the at least one array of holographic lenses, wherein
each individual cell of the array optical component includes a reflector of the array of reflectors and a respective holographic lens of the at least one array of holographic lenses,
the reflector and holographic lens are disposed opposite to each other on either side of the support and with respective reflective faces of the reflector and the holographic lens are located facing each other, and
each holographic lens of the at least one array of holographic lenses is provided with a respective through opening for passing light at each of the individual cells of the array optical component.

2. The array optical component according to claim 1, wherein in at least one of the individual cells, a through opening in the respective holographic lens of each of the at least one array of holographic lenses is centred to the one individual cell.

3. The array optical component according to claim 1, wherein in at least one of the individual cells the through opening extends along a surface registered within a projection of the reflector in a plane of the at least one array of holographic lenses.

4. The array optical component according to claim 1, wherein the component is configured to focus a light beam impinging at normal incidence on individual cells into a series of predetermined points, with points of the series of predetermined points all extending in a same plane parallel to the support.

5. The array optical component according to claim 4, wherein the plane parallel to the support is located outside the array optical component, on a side of the at least one array of holographic lenses.

6. The array optical component according to claim 1, wherein in at least one of the individual cells, the reflector is formed by a dichroic mirror, optically reflecting at at least one focusing wavelength by each holographic lens of a same individual cell.

7. The array optical component according to claim 1, wherein in at least one of the individual cells, the reflector is formed by at least one reflection hologram.

8. The array optical component according to claim 7, wherein the reflector is configured to reflect light at a reflection angle distinct from an incidence angle, in absolute value.

9. The array optical component according to claim 1, wherein in at least one of the individual cells, the respective holographic lens of each of the at least one array of holographic lenses is formed by a plurality of elementary holograms each configured to deflect light by a predetermined angle.

10. The array optical component according to claim 1, wherein the component includes a plurality of arrays of holographic lenses, superimposed with one another along an axis orthogonal to a plane of a lower face of the support, and each configured to focus light at a distinct predetermined wavelength.

11. The array optical component according to claim 1, wherein the component includes a single array of holographic lenses, including different types of holographic lenses which differ from each other in focusing wavelength.

12. An optical system including comprising an array optical component according to claim 1 superimposed with an array of photodetectors, wherein the individual cells of the array optical component are distributed in at least one first distribution step and the photodetectors of the array of photodetectors are distributed in at least one second distribution step, and the first and second distribution steps are distinct from each other and not multiple of each other.

13. A replication optical component for manufacturing an array optical component according to claim 1, comprising:
a superimposition of a primary array of holographic lenses, an array of opaque elements and a substrate, with the array of opaque elements being disposed between the substrate and the primary array of holographic lenses, wherein:
each holographic lens of the primary array is formed by a plurality of elementary reflection holograms, each being configured to deflect light by a predetermined angle; and
each holographic lens of the primary array is provided with an opening within which one of the opaque elements of the array of opaque elements is located.

14. A method for manufacturing an array optical component according to claim 1, comprising:
superimposing a replication optical component and a writing assembly, wherein
the replication optical component comprises:
a superimposition of a primary array of holographic lenses, an array of opaque elements and a substrate, with the array of opaque elements being disposed between the substrate and the primary array of holographic lenses, wherein:
each holographic lens of the primary array is formed by a plurality of elementary reflection holograms, each being configured to deflect light by a predetermined angle; and
each holographic lens of the primary array is provided with an opening within which one of the opaque elements of the array of opaque elements is located, and
the writing assembly includes a superimposition of a writing layer of photosensitive material, a support and an array of reflectors, wherein the support is disposed between the writing layer and the array of reflectors, and the writing layer is disposed between the support and the primary array of holographic lenses of the replication optical component;
registering a secondary array of holographic lenses into the writing layer by exposing a stack including the superimposed replication optical component and writing assembly; and
translating the replication optical component relative to the writing assembly and re-registering a secondary array of holographic lenses in the writing layer, the translation and re-registration steps being implemented several times.

15. A replication optical component for manufacturing an array optical component according to claim 1, comprising a superimposition of an array of microlenses and an array of spatial filters, wherein each of the microlenses is a refractive lens and wherein the array of spatial filters includes opaque elements each being located facing a respective one of the microlenses.
